(19) United States
(12) Patent Application Publication
(10) Pub. No.: US 2022/0305624 A1
(43) Pub. Date: Sep. 29, 2022

(54) RATCHET SCREWDRIVER WITH IMPROVED ROTATION EFFICIENCY

(71) Applicant: Zheng Kai Hardware Products (Nantong) Co., Ltd., Nantong City (CN)

(72) Inventor: Shwu-Ruu Chern, Taichung (TW)

(21) Appl. No.: 17/212,899

(22) Filed: Mar. 25, 2021

(51) Int. Cl. B25B 15/04; B25B 13/46

(52) U.S. Cl. CPC B25B 15/04; B25B 13/465

(57) ABSTRACT

A ratchet screwdriver with improved rotation efficiency includes: a grip; a driving assembly installed to a first assembly portion of the grip; a ring seat assembly installed to a second assembly portion and having a multiple of extension arms and a ring seat; a planetary gear set installed to a gear assembly portion of the ring seat; a rotary head installed to an end of the driving assembly and having a screwdriver assembly portion passing through a through-opening of the ring seat; a ring sleeve sheathed on an end of the driving assembly and having a ring-shaped gear installed to an inner side of the ring sleeve. Each extension arm can increase the arm of force of the ring seat assembly when linked and improve the rotation efficiency.

### FIELD OF INVENTION

The present invention relates to a ratchet screwdriver with improved rotation efficiency, in particular to a novel structure of a ratchet screwdriver capable of improving the rotation efficiency to save time and effort.

### BACKGROUND OF INVENTION

### 1. Description of the Related Art

As the development of hand tool technology booms, traditional screwdrivers have evolved from a single-piece structure to a ratchet structure which allows users to complete a screw locking operation through continuous reciprocating actions. Although the traditional ratchet screwdriver has the effect of completing the screw locking operation quickly through the continuous reciprocating actions, yet the screwdriver still rotates at a rotation rate of 1:1. Even if the ratchet screwdriver has different rates of rotation, the internal structure does not have enough arm of force to improve the rotation efficiency, so that there is a still a disadvantage of requiring a laborious rotation when the screwdriver rotates. Therefore, although the traditional structure has been used for many years and can achieve the aforementioned basic functions, the structural design still requires further improvements.

### 2. Summary of the Invention

Therefore, it is a primary objective of the present invention to overcome the aforementioned drawbacks by providing an innovative structure capable of saving efforts, improving the efficiency of rotation and the convenience of use. To achieve the aforementioned and other objectives, the present invention discloses a ratchet screwdriver with improved rotation efficiency, including: a grip, having a first assembly portion and a second assembly portion; a driving assembly, installed to the first assembly portion of the grip and synchronously moving with the grip; a ring seat assembly, installed to the second assembly portion of the grip, and including a plurality of extension arms extending and spaced apart therefrom, and a ring seat disposed at an end of the extension arm, and the ring seat including a through-opening and a plurality of circularly distributed gear assembly portions; a planetary gear set, installed to the gear assembly portion of the ring seat; a rotary head, installed to an end of the driving assembly and having a synchronous coordination relationship, and the rotary head including a screwdriver assembly portion in an extended form and an active gear installed around the outer periphery of the screwdriver assembly portion, so that the screwdriver assembly portion is passed and extended into the through-opening of the ring seat, and the active gear and the inner side of the planetary gear set are in a rotational coordination; and a ring sleeve, sheathed on an end of the driving assembly and having a synchronous coordination relationship, and the ring sleeve having a ring-shaped gear installed on an inner side thereof, so that an outer side of the planetary gear set and the ring-shaped gear are in a rotational coordination relationship; wherein each of the extension arms increases the arm of force when the ring seat assembly is linked, and the active gear of the rotary head, the planetary gear set, and a ring-shaped gear of the ring sleeve form a gear coordination relationship to improve the rotation efficiency.

### BRIEF DESCRIPTION OF THE DRAWINGS

FIG. 1 is an exploded view of the present invention;

FIG. 2 is another exploded view of the present invention;

FIG. 3 is a perspective view of an embodiment of the present invention;

FIG. 4 is a perspective view of the present invention; and

FIG. 5 is a perspective view of the present invention viewing from another angle.

### DESCRIPTION OF THE PREFERRED EMBODIMENTS

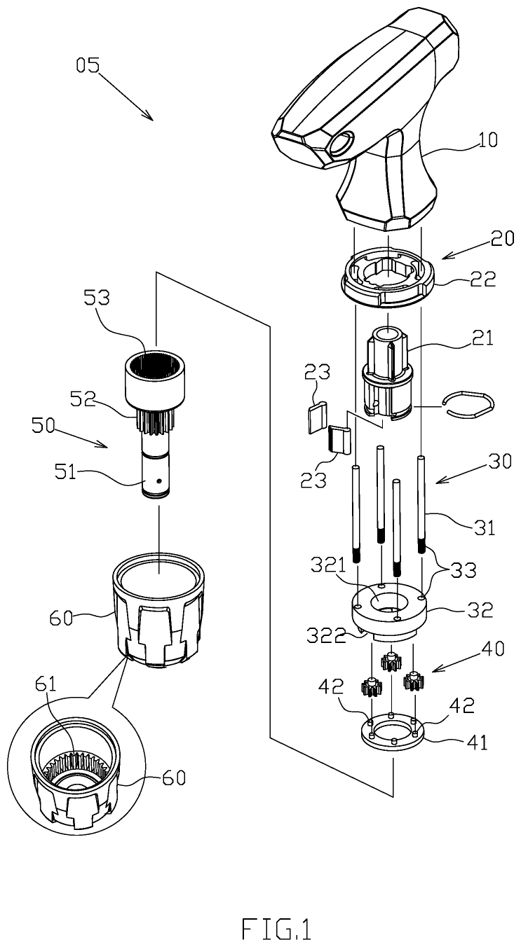

With reference to FIGS. 1 to 4 for a ratchet screwdriver 05 with improved rotation efficiency in accordance with the present invention, the ratchet screwdriver 05 includes:

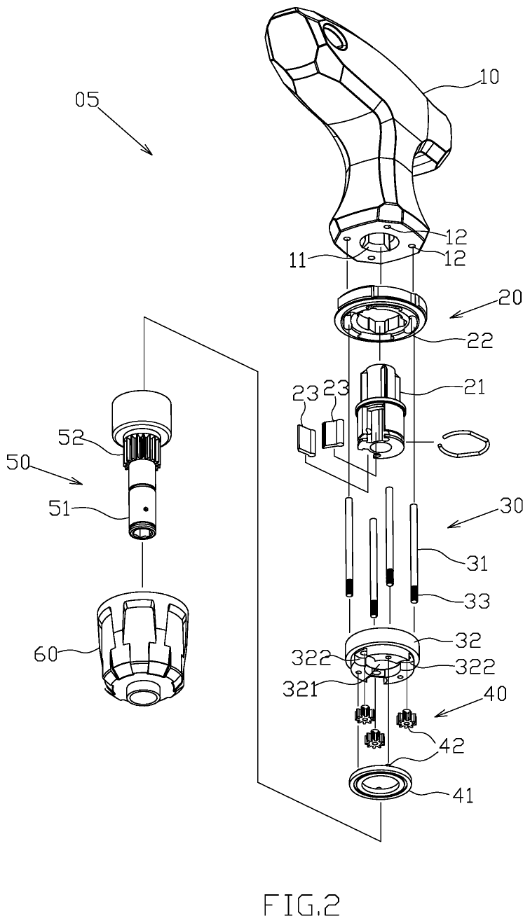

a grip 10, having a first assembly portion 11 and a second assembly portion 12 (as shown in FIG. 2);

a driving assembly 20, installed to the first assembly portion 11 of the grip 10, and moving synchronously with the grip 10;

a ring seat assembly 30, installed to the second assembly portion 12 of the grip 10, and including a plurality of extension arms 31 extending and spaced apart from the ring seat assembly 30 and a ring seat 32 disposed at an end of the extension arm 31, and the ring seat 32 including a through-opening 321 and a plurality of circularly distributed gear assembly portions 322; wherein in an embodiment of the present invention, the extension arms 31 are spaced and circularly arranged into a four-rod form, and the second assembly portion of the grip 10 is spaced and circularly arranged into a positioning hole form in order to insert the extension arm into the second assembly portion 12;

a planetary gear set 40, installed to the gear assembly portion 322 of the ring seat 32, wherein the planetary gear set has a limit cover 41 installed at an end without the ring seat 32, and a limit rim portion 42 (which is only labeled in FIGS. 1 and 2) of a concave-convex fit type is disposed at a relative position of the planetary gear set 40 and the limit cover 41;

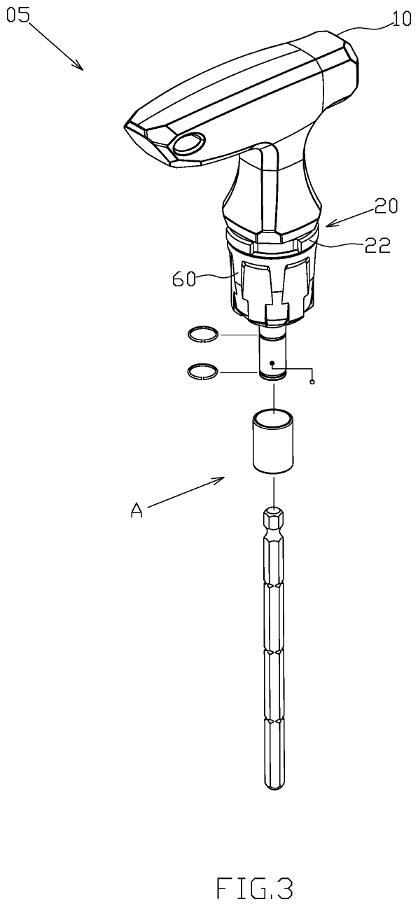

a rotary head 50, installed to an end of the driving assembly 20 and having a synchronous coordination relationship, and the rotary head 50 including a screwdriver assembly portion 51 in an extended form and an active gear 52 around the outer periphery of the screwdriver assembly portion, so that the screwdriver assembly portion 51 is passed and extended into the through-opening 321 of the ring seat 32, and the active gear 52 and the inner side of the planetary gear set 40 are in a rotational coordination relationship, wherein the screwdriver assembly portion 51 of the rotary head 50 disclosed in the present invention can be equipped with a predetermined screwdriver head set A (which is labeled in FIG. 3 only), and the type of the screwdriver head set A is a prior art, but not limited to a conventional one; and

a ring sleeve 60, sheathed on an end of the driving assembly 20, and having a synchronous coordination relationship, and the ring sleeve 60 having a ring-shaped gear 61 (which is labeled in FIG. 1 only) on an inner side of the ring sleeve 60, so that an outer side of the planetary gear set 40 and the ring-shaped gear 61 are in a rotational coordination relationship.

As illustrated in the embodiments, the present invention can achieve the following effects:

In FIG. 1, a screwing portion 33 is disposed at a relative position of an end of the extension arm 31 of the ring seat assembly 30 and the ring seat 32, so that the extension arm 31 and the ring seat 32 have a detachable assembly relationship, and an end of each extension arm 31 without the ring seat 32 is passed through the link plate 22 and situated in a link coordination status with the second assembly portion 12 of the grip 10.

In an embodiment as shown in FIG. 1, the driving assembly 20 includes a shaft 21 and a link plate 22 set on the shaft 21, a plurality of engaging members 23 with a serrated end disposed at and spaced from a predetermined position of the shaft 21, and an inner ring gear 53 installed on an inner side of the rotary head 50 and configured to be opposite to the shaft 21, so that the shaft 21 is coordinated and linked with the rotary head 50 through the engaging members 23 and the inner ring gear 53.

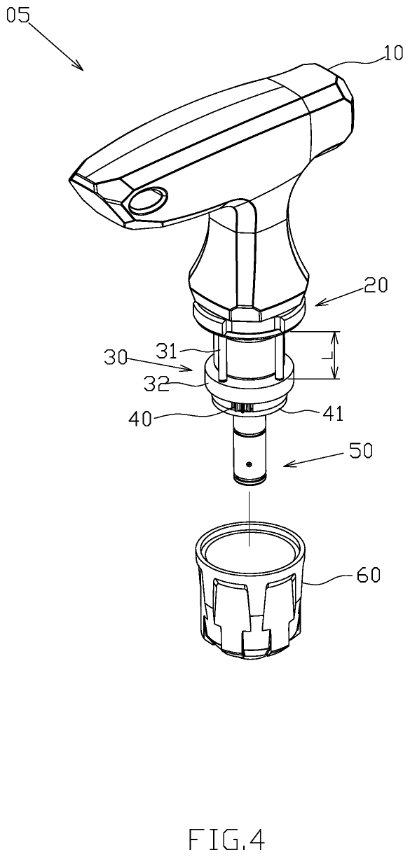

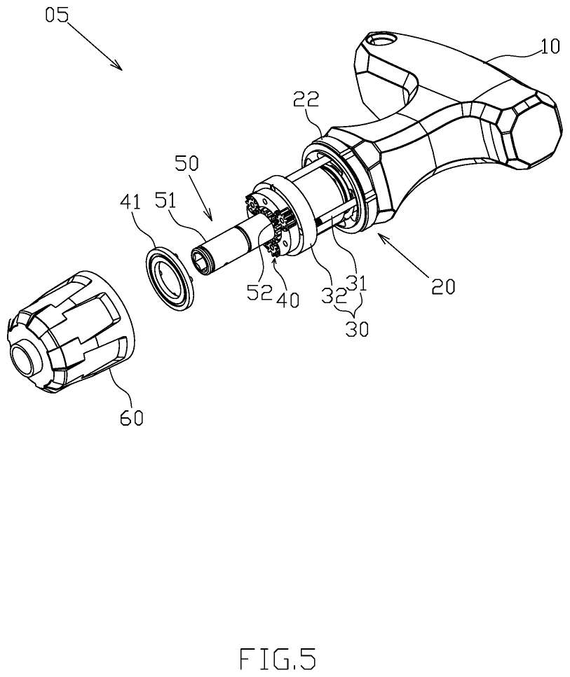

In FIGS. 4 and 5, each of the extension arms 31 can increase the arm of force (labelled as L in FIG. 4) of the ring seat assembly 30 when linked. In other words, the arm of force is lengthened during the rotation, so as to save effort for the rotation, and the gear coordination relationship among the active gear 52 of the rotary head 50, the planetary gear set 40, and the ring-shaped gear 61 of the ring sleeve 60 can improve the rotation efficiency effectively.

What is claimed is:

1. A ratchet screwdriver with improved rotation efficiency, comprising:
a grip, including a first assembly portion and a second assembly portion;
a driving assembly, installed to the first assembly portion of the grip and synchronously moving with the grip;
a ring seat assembly, installed to the second assembly portion of the grip, and including a plurality of extension arms extending and spaced apart therefrom, and a ring seat disposed at an end of the extension arm, and the ring seat including a through-opening and a plurality of circularly distributed gear assembly portions;
a planetary gear set, installed to the gear assembly portion of the ring seat;
a rotary head, installed to an end of the driving assembly and having a synchronous coordination relationship, and the rotary head including a screwdriver assembly portion in an extended form and an active gear installed around the outer periphery of the screwdriver assembly portion, so that the screwdriver assembly portion is passed and extended into the through-opening of the ring seat, and the active gear and the inner side of the planetary gear set are in a rotational coordination; and
a ring sleeve, sheathed on an end of the driving assembly and having a synchronous coordination relationship, and the ring sleeve having a ring-shaped gear installed on an inner side thereof, so that an outer side of the planetary gear set and the ring-shaped gear are in a rotational coordination relationship;
wherein each of the extension arms increases the arm of force when the ring seat assembly is linked, and the active gear of the rotary head, the planetary gear set, and a ring-shaped gear of the ring sleeve form a gear coordination relationship to improve the rotation efficiency.

2. The ratchet screwdriver with improved rotation efficiency as claimed in claim 1, wherein the driving assembly comprises a shaft and a link plate set on the shaft, a plurality of engaging members with a serrated end disposed at and spaced from a predetermined position of the shaft, and an inner ring gear installed on an inner side of the rotary head and configured to be opposite to the shaft, so that the shaft is coordinated and linked with the rotary head through the engaging members and the inner ring gear.

3. The ratchet screwdriver with improved rotation efficiency as claimed in claim 2, wherein a screwing portion is disposed at a relative position of an end of the ring seat assembly with the extension arm and the ring seat, so that the extension arm and the ring seat have a detachable installation and removal relationship, and an end of each of the extension arms without the ring seat is passed through the link plate and situated in a link coordination status with the second assembly portion of the grip.

4. The ratchet screwdriver with improved rotation efficiency as claimed in claim 3, wherein the extension arms are spaced and circularly arranged into a four-rod form, and the second assembly portion of the grip is spaced and circularly arranged into a positioning hole form in order to insert the extension arm into the second assembly portion.

5. The ratchet screwdriver with improved rotation efficiency as claimed in claim 4, wherein the planetary gear set has a limit cover installed at an end of the planetary gear set without the ring seat, and a limit rim portion of a concave-convex fit type disposed at a relative position of the planetary gear set and the limit cover.
